(19) United States
(12) Patent Application Publication
(10) Pub. No.: US 2017/0024782 A1
(43) Pub. Date: Jan. 26, 2017

(54) METHODS AND SYSTEMS FOR REMINDING USER REQUESTS

(71) Applicant: Noodoe Corporation, Taipei City (TW)

(72) Inventor: John C. Wang, Taipei City (TW)

(21) Appl. No.: 15/206,408

(22) Filed: Jul. 11, 2016

(30) Foreign Application Priority Data
Jul. 21, 2015 (TW) 104123487

(51) Int. Cl. G06Q 30/02; H04L 29/08; G08B 21/24

(52) U.S. Cl. CPC G06Q 30/0281; G08B 21/24; H04L 67/12; G06Q 50/10

(57) ABSTRACT

Methods and systems for reminding user requests are provided. First, at least one specific electronic device generates specific data corresponding to a request of a user, and transmits the specific data via a first network. Then, an intermediate electronic device receives the specific data from the specific electronic device via the first network, and performs a request management process for the specific data, wherein the request management process is performed according to the time at which the specific data is received by the intermediate electronic device. When a result of the request management process conforms to a predefined condition, the intermediate electronic device generates a reminder to prompt the request corresponding to the specific electronic device.

### BACKGROUND OF THE INVENTION

Field of the Invention

The disclosure relates generally to methods and systems for reminding user requests, and, more particularly to methods and systems that can receive data corresponding to user requests from an electronic device, perform related managements for the received data, and perform related reminding processes for the requests.

Description of the Related Art

In the service industry, the best way to increase customer satisfaction is by directly providing appropriate and immediate services to customers. For example, when a customer needs a specific service, such as ordering food, having their water refilled, or receiving the check, the customer always raises a hand to let the waiter noticed the customer's requests. However, during busy times, it is not easy to find a waiter, or the customer's requests cannot be handled in real-time, resulting in customer dissatisfaction. Currently, wireless service bells have been deployed in some restaurants. Customers can push a service bell set on the table when they need a service. The service bell can wirelessly transmit signals to reception equipment set on a counter or it can be worn by a waiter, so that the customers' requirement can be known by the waiter without delay.

Conventionally, the service bell generates wireless signals only at the moment the service bell is pushed. The reception equipment may miss the wireless signals when any indeterminate environment or anthropic factor exists in the restaurant during the period of the generation of wireless signals. Even if the reception equipment correctly receives the wireless signals, a waiter may ignore the corresponding request since the waiter may be busy and the reception equipment cannot continuously repeat the request. Additionally, since several reception devices may simultaneously receive wireless signals generated by the service bell, a customer request may be served by several waiters, or by none, since they may assume another waiter has already handled the request.

On the other hand, with the coming of TOT (Internet Of Things), every type of device or object can connect to networks, and users can access and control these devices or objects via networks. The rapid development of TOT is fortunate that the underlying foundation of wireless network technology is already very mature. Electronic devices can readily connect with each other to perform related applications via wireless networks. Additionally, the BLE (Bluetooth Low Energy) technology has solved the prohibitive power consumption issue caused by prolonged connections of electronic devices to wireless networks. There exists an opportunity to significantly reduce the drawbacks of prior arts, and improve customer satisfaction by integrating the wireless service bell with TOT technology.

### BRIEF SUMMARY OF THE INVENTION

Methods and systems for reminding user requests are provided, wherein an electronic device can generate and transmit data corresponding to user requests, and another electronic device can receive the data, perform related managements for the received data, and perform related reminding processes for the requests.

In an embodiment of a method for reminding user requests, specific data corresponding to a request of a user is generated by at least one specific electronic device, and the specific data is transmitted via a first network. The specific data is received from the at least one specific electronic device via the first network by an intermediate electronic device, and a request management process is performed for the specific data, wherein the request management process is performed according to the time at which the specific data is received by the intermediate electronic device. When a result of the request management process conforms to a predefined condition, a reminder is generated to prompt the request corresponding to the at least one specific electronic device by the intermediate electronic device.

An embodiment of a system for reminding user requests comprises at least one specific electronic device and an intermediate electronic device. The at least one specific electronic device generates specific data corresponding to a request of a user, and transmits the specific data via a first network. The intermediate electronic device receives the specific data from the at least one specific electronic device via the first network, and performs a request management process for the specific data, wherein the request management process is performed according to the time at which the specific data is received by the intermediate electronic device. When a result of the request management process conforms to a predefined condition, the intermediate electronic device generates a reminder to prompt the request corresponding to the specific electronic device.

In some embodiments, the request management process calculates an accumulated time after the specific data is received by the intermediate electronic device, and when the accumulated time equals to a predefined time value, the reminder is generated.

In some embodiments, the specific electronic device comprises at least one sensor for detecting a motion and/or posture corresponding to the specific electronic device. The specific electronic device generates the specific data according to the motion and/or posture corresponding to the specific electronic device.

In some embodiments, the specific electronic device comprises at least one physical key. When the physical key is pressed, the specific electronic device generates the specific data.

In some embodiments, the specific electronic device determines whether a specific condition is met or not. When the specific condition is met, the specific electronic device generates the specific data.

In an embodiment of a method for reminding user requests, specific data corresponding to a request of a user is generated by at least one specific electronic device, and the specific data is transmitted via a first network. The specific data is received from the at least one specific electronic device via the first network by an intermediate electronic device, and the specific data is transmitted to a server via a second network by the intermediate electronic device. A request management process is performed for the specific data by the server, wherein the request management process is performed according to the time at which the specific data is received by the intermediate electronic device or the server. When a result of the request management process conforms to a predefined condition, a reminder is generated to prompt the request corresponding to the at least one specific electronic device by the server.

An embodiment of a system for reminding user requests comprises at least one specific electronic device, an intermediate electronic device, and a server. The at least one specific electronic device generates specific data corresponding to a request of a user, and transmits the specific data via a first network. The intermediate electronic device receives the specific data from the at least one specific electronic device via the first network, and transmits the specific data to the server via a second network. The server performs a request management process for the specific data wherein the request management process is performed according to the time at which the specific data is received by the intermediate electronic device or the server. When a result of the request management process conforms to a predefined condition, the server generates a reminder to prompt the request corresponding to the at least one specific electronic device.

In some embodiments, a terminal electronic device obtains the specific data and the result of the request management process from the server.

In some embodiments, the request management process calculates an accumulated time after the specific data is received by the intermediate electronic device or the server, and when the accumulated time equals to a predefined time value, the reminder is generated.

In an embodiment of a method for reminding user requests, specific data corresponding to a request of a user is generated by at least one specific electronic device, and the specific data is transmitted via a first network. The specific data is received from the at least one specific electronic device via the first network by an intermediate electronic device, and the specific data is transmitted to a server via a second network by the intermediate electronic device. The specific data is received from the server by a terminal electronic device, and a request management process is performed for the specific data by the terminal electronic device, wherein the request management process is performed according to the time at which the specific data is received by the intermediate electronic device, the server or the terminal electronic device. When a result of the request management process conforms to a predefined condition, a reminder is generated to prompt the request corresponding to the at least one specific electronic device by the terminal electronic device.

An embodiment of a system for reminding user requests comprises at least one specific electronic device, an intermediate electronic device, a server, and a terminal electronic device. The at least one specific electronic device generates specific data corresponding to a request of a user, and transmits the specific data via a first network. The intermediate electronic device receives the specific data from the at least one specific electronic device via the first network, and transmits the specific data to the server via a second network. The terminal electronic device receives the specific data from the server, and performs a request management process for the specific data, wherein the request management process is performed according to the time at which the specific data is received by the intermediate electronic device, the server or the terminal electronic device. When a result of the request management process conforms to a predefined condition, the terminal electronic device generates a reminder to prompt the request corresponding to the at least one specific electronic device.

Methods for reminding user requests may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a system for reminding user requests of the invention;

FIG. 2 is a schematic diagram illustrating an embodiment of a specific electronic device of the invention;

FIG. 3 is a schematic diagram illustrating another embodiment of a specific electronic device of the invention;

FIG. 4 is a schematic diagram illustrating another embodiment of a specific electronic device of the invention;

FIG. 5 is a flowchart of an embodiment of a method for reminding user requests of the invention;

FIG. 6 is a schematic diagram illustrating another embodiment of a system for reminding user requests of the invention;

FIG. 7 is a schematic diagram illustrating another embodiment of a system for reminding user requests of the invention;

FIG. 8 is a flowchart of another embodiment of a method for reminding user requests e of the invention;

FIG. 9 is a schematic diagram illustrating another embodiment of a system for reminding user requests of the invention;

FIG. 10 is a flowchart of another embodiment of a method for reminding user requests e of the invention;

FIG. 11 is a flowchart of an embodiment of a method for generating specific data of the invention;

FIG. 12 is a flowchart of another embodiment of a method for generating specific data of the invention; and

FIG. 13 is a flowchart of another embodiment of a method for generating specific data of the invention.

### DETAILED DESCRIPTION OF THE INVENTION

Methods and system for reminding user requests are provided.

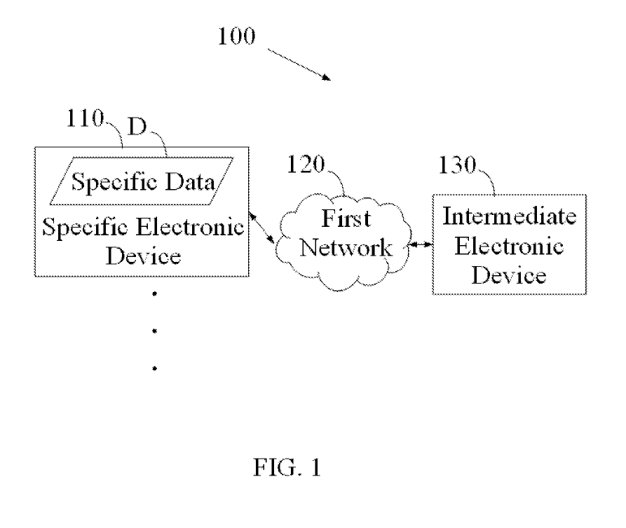

FIG. 1 is a schematic diagram illustrating an embodiment of a system for reminding user requests of the invention. The system for reminding user requests 100 comprises at least one specific electronic device 110 and an intermediate electronic device 130. The specific electronic device 110 and the intermediate electronic device 130 may be any electronic device having network connecting capabilities. The specific electronic device 110 can generate specific data D corresponding to a request of a user, and transmits the specific data D via a first network 120, such as a wired or a wireless network such as a Wi-Fi or a Bluetooth network. The intermediate electronic device 130 can receive the specific data D, which is transmitted from the different specific electronic devices 110, and perform a request management process for the specific data D corresponding to the specific electronic device 110. The details of the request management process will be discussed later.

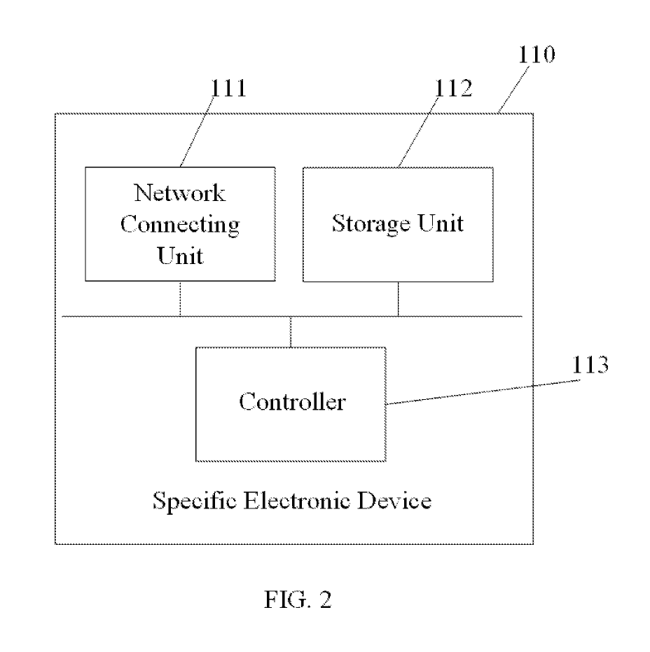

FIG. 2 is a schematic diagram illustrating an embodiment of a specific electronic device of the invention. As shown in FIG. 2, the specific electronic device 110 comprises a network connecting unit 111, a storage unit 112, and a controller 113. The network connecting unit 111 can transmit data and/or connect to other electronic devices having network connecting capabilities via a network, such as a wired or a wireless network such as Wi-Fi or Bluetooth network. It is understood that, in some embodiments, the network connecting unit 111 may be a network connecting unit implemented with a low-power consumption technology, such as Bluetooth Smart technology. The network connecting unit 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected to other electronic devices. The storage unit 112 can store related data, such as identification data corresponding to the specific electronic device 110. The controller 113 can control related operations of hardware and software in the specific electronic device 110.

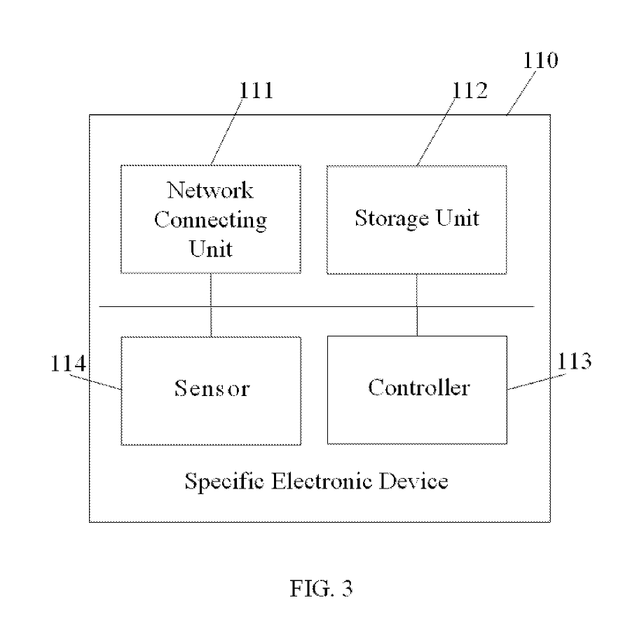

FIG. 3 is a schematic diagram illustrating another embodiment of a specific electronic device of the invention. As shown in FIG. 3, the specific electronic device 110 comprises a network connecting unit 111, a storage unit 112, at least one sensor 114, and a controller 113. The network connecting unit 111 can transmit data and/or connect to other electronic devices having network connecting capabilities via a network, such as a wired or wireless network such as Wi-Fi or Bluetooth network. Similarly, in some embodiments, the network connecting unit 111 may be a network connecting unit implemented with a low-power consumption technology, such as Bluetooth Smart technology. The network connecting unit 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected by other electronic devices. The storage unit 112 can store related data, such as identification data corresponding to the specific electronic device 110. It is understood that, in some embodiments, the sensor 114 can detect a posture and/or motion corresponding to the specific electronic device 110. For example, the sensor 114 may be an accelerometer for generating information of velocity and displacement when the device moves. In another example, the sensor 114 may be a Gyro sensor for generating information of angular acceleration when the device moves. In another example, the sensor 114 may be an e-compass for detecting an angle of the device in regard to a geographical direction, such as the direction of the North Pole or the South Pole. It is noted that, the above sensors are only examples of the present application, and the present invention is not limited thereto. Any sensor that can detect the posture and/or motion of an electronic device can be applied in the present invention. As described, the sensor 114 can detect the posture of the specific electronic device 110. It is understood that, in some embodiments, the posture can be the angular information of the specific electronic device 110 in regard to at least one reference point. In some embodiments, the posture of the specific electronic device 110 can be represented by an angle corresponding to an axis which is vertical to at least one plane of the specific electronic device 110 in regard to a specific direction, such as the gravity direction or the geographical direction. Additionally, in some embodiments, the sensor 114 can detect an environmental factor. For example, the sensor 114 may be a temperature sensor for detecting the temperature of an environment where the specific electronic device 110 is in. In another example, the sensor 114 may be a pressure sensor for detecting the pressure of an environment where the specific electronic device 110 is in. It is noted that, the above sensor are only examples of the present application, and the present invention is not limited thereto. The controller 113 can control related operations of hardware and software in the specific electronic device 110. The controller 113 can determine whether to generate related data according to the data output by the sensor 114.

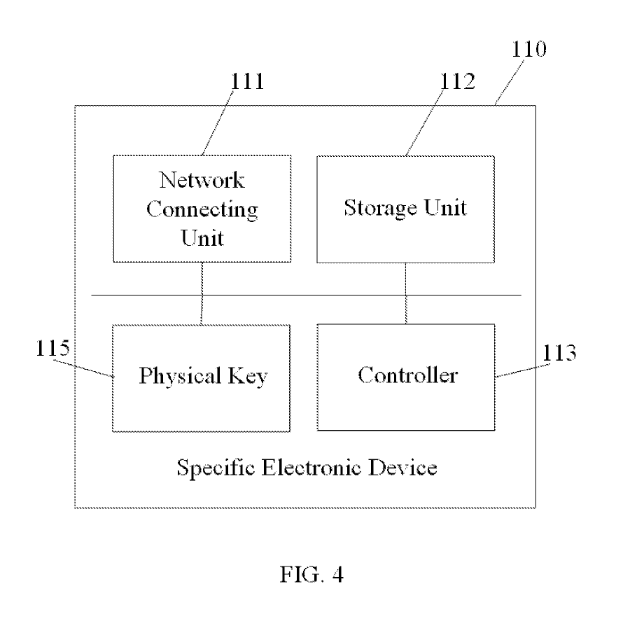

FIG. 4 is a schematic diagram illustrating another embodiment of a specific electronic device of the invention. As shown in FIG. 4, the specific electronic device 110 comprises a network connecting unit 111, a storage unit 112, at least one physical key 115, and a controller 113. The network connecting unit 111 can transmit data and/or connect to other electronic devices having network connecting capabilities via a network, such as a wired or wireless network such as Wi-Fi or Bluetooth network. Similarly, in some embodiments, the network connecting unit 111 may be a network connecting unit implemented with a low-power consumption technology, such as Bluetooth Smart technology. The network connecting unit 111 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected to other electronic devices. The storage unit 112 can store related data, such as identification data corresponding to the specific electronic device 110. The controller 113 can control related operations of hardware and software in the specific electronic device 110. The controller 113 can determine whether to generate related data according to whether the physical key 115 is pressed or not and/or the type of the pressed physical key 115.

As described, the intermediate electronic device 130 may be any electronic device having network connecting capabilities. The intermediate electronic device 130 may be a computer or a portable device, such as a mobile phone, a smart phone, a PDA (Personal Digital Assistant), a GPS (Global Positioning System), a notebook, or a tablet computer. In some embodiments, the intermediate electronic device 130 may have a network connecting unit implemented with a low-power consumption technology, such as Bluetooth Smart technology. The network connecting unit of the intermediate electronic device 130 has two modes, such as a central mode and a peripheral mode. In the central mode, the network connecting unit can receive data from the network connecting units of other electronic devices, and the network connecting unit can actively connect to other electronic devices. In the peripheral mode, the network connecting unit can broadcast signals, such as its identification data. However, the network connecting unit cannot actively connect to other electronic devices in the peripheral mode. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices.

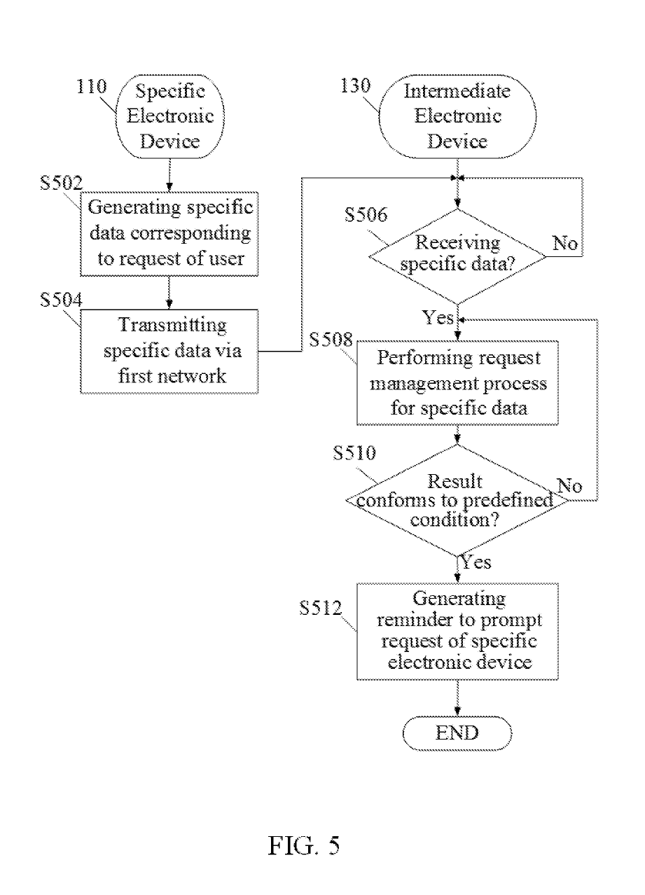

FIG. 5 is a flowchart of an embodiment of a method for reminding user requests of the invention.

In step S502, the specific electronic device 110 generates specific data corresponding to a request of a user, and in step S504, transmits the specific data via a first network 120, such as a wired or wireless network such as Wi-Fi or Bluetooth network by using the network connecting unit 111. It is noted that, the specific electronic device 110 can generate the specific data according to different applications and requirements, which will be discussed later. It is understood that, in some embodiments, the network connecting unit 111 may be a network connecting unit implemented with a low-power consumption technology, such as Bluetooth Smart technology. The Bluetooth Smart technology supports two modes, such as central and peripheral. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected by other electronic devices. In step S506, the intermediate electronic device 130 determines whether any specific data is received via a network. Similarly, in some embodiments, the network connecting unit of the intermediate electronic device 130 may be a network connecting unit implemented with a low-power consumption technology, such as Bluetooth Smart technology. The Bluetooth Smart technology supports two modes: central and peripheral. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices. When no specific data is received (No in step S506), the procedure remains at step S506. When specific data is received (Yes in step S506), in step S508, a request management process is performed for the specific data. It is noted that, the request management process is performed according to the time at which the specific data D is received by the intermediate electronic device 130. It is understood that, in some embodiments, the request management process calculates an accumulated time after the specific data D is received by the intermediate electronic device 130. Then, in step S510, it is determined whether a result of the request management process conforms to a predefined condition. When a result of the request management process does not conform to a predefined condition (No in step S510), the procedure returns to step S508. When a result of the request management process conforms to a predefined condition (Yes in step S510), in step S512, a reminder is generated to prompt the request corresponding to the specific electronic device by the intermediate electronic device 130. As described, in some embodiments, the request management process calculates an accumulated time after the specific data D is received by the intermediate electronic device 130. When the accumulated time equals to a predefined time value, it represents that the result of the request management process conforms to the predefined condition, and the reminder is generated. It is understood that, in some embodiments, the reminder may comprise a sound, vibration, or any data, such as text or figure, which can be displayed. Additionally, in some embodiments, the intermediate electronic device 130 can display the result of the request management process via a display unit. It is noted that, the presentation manner of the result of the request management process can be implemented based on various designs. For example, the displayed result may be the accumulated time after the specific data D is received by the intermediate electronic device 130, which can be counted in seconds. In another example, a predefined time value can be counted down based on the accumulated time after the specific data D is received by the intermediate electronic device 130.

It is noted that, in some embodiments, the identification data corresponding to the specific electronic device 110 can be transmitted along with the specific data generated by the specific electronic device 110. The intermediate electronic device 130 will record and perform subsequent managements for the received identification data and the specific data.

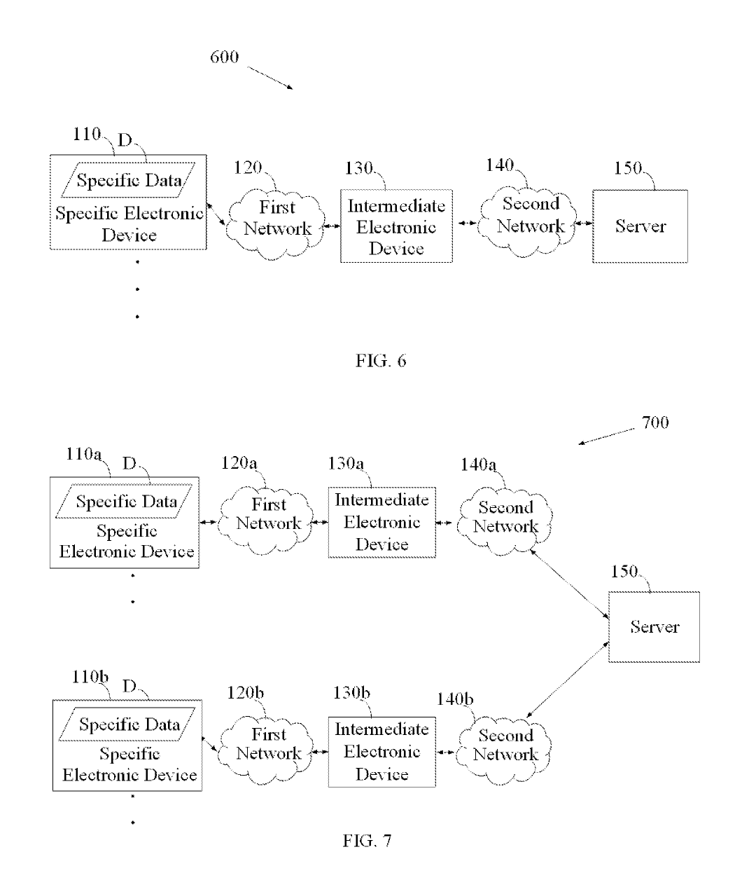

FIG. 6 is a schematic diagram illustrating another embodiment of a system for reminding user requests of the invention. The system for reminding user requests 600 comprises at least one specific electronic device 110, an intermediate electronic device 130, and a server 150. The specific electronic device 110 and the intermediate electronic device 130 may be any electronic device having network connecting capabilities. The specific electronic device 110 can generate specific data D corresponding to a request of a user, and transmit and/or broadcast the specific data D via a first network 120, such as a wired or a wireless network such as a Wi-Fi or a Bluetooth network. The intermediate electronic device 130 can receive the specific data D, which is transmitted from the different specific electronic devices 110a via the first network 120, and transmit the specific data D to the server 150 via a second network 140, such as a wired or a wireless network. The server 150 can perform a request management process for the specific data D corresponding to the specific electronic device 110, which will be discussed later.

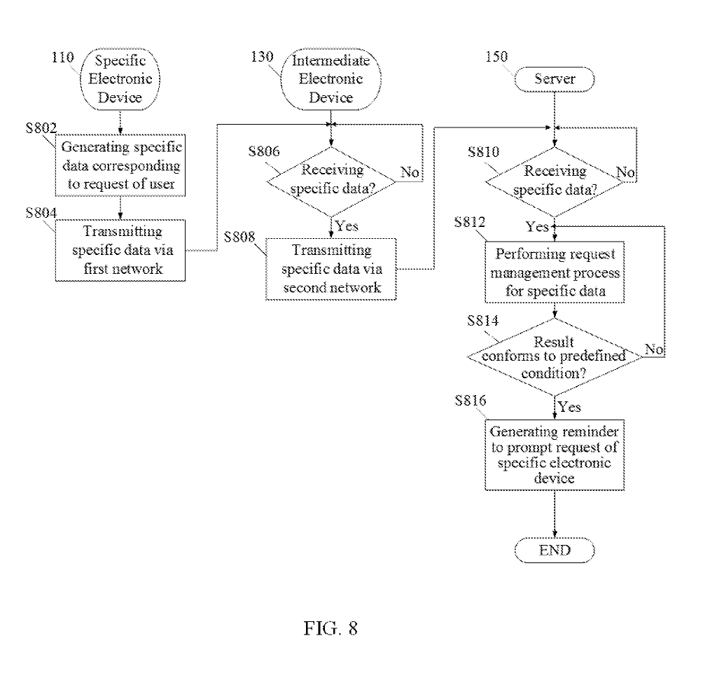

FIG. 7 is a schematic diagram illustrating another embodiment of a system for reminding user requests of the invention. The system for reminding user requests 700 comprises at least one specific electronic device 110a and an intermediate electronic device 130a. The specific electronic device 110a and the intermediate electronic device 130a may be any electronic device having network connecting capabilities. The specific electronic device 110a can generate specific data D corresponding to a request of a user, and transmit and/or broadcast the specific data D via a first network 120a, such as a wired or a wireless network such as a Wi-Fi or a Bluetooth network. The intermediate electronic device 130a can receive the specific data D, which is transmitted from the different specific electronic devices 110a via the first network 120a. The intermediate electronic device 130a can connect to a server 150 via a second network 140a, such as a wired or a wireless network. Additionally, the system for reminding user requests 700 further comprises at least one specific electronic device 110b and an intermediate electronic device 130b. The specific electronic device 110b and the intermediate electronic device 130b may be any electronic device having network connecting capabilities. The specific electronic device 110b can generate specific data D corresponding to a request of a user, and transmit and/or broadcast the specific data D via a first network 120b, such as a wired or a wireless network such as a Wi-Fi or a Bluetooth network. The intermediate electronic device 130b can receive the specific data D, which is transmitted from the different specific electronic devices 110b via the first network 120a. The intermediate electronic device 130b can connect to the server 150 via a second network 140b, such as a wired or a wireless network. The server 150 can perform a request management process for the specific data D respectively received from the different intermediate electronic devices 130a and 130b, which will be discussed later. It is understood that, in some embodiments, the intermediate electronic devices 130a and 130b can be deployed in the same place, such as a restaurant. In some embodiments, the intermediate electronic devices 130a and 130b can be respectively deployed in the different places.

It is understood that, in some embodiments, a terminal electronic device, such as a smart phone can connect to the server 150, and obtain and display the specific data and the result of the request management process from the server 150.

FIG. 8 is a flowchart of another embodiment of a method for reminding user requests of the invention. It is understood that, in the embodiments, the specific electronic device 110 may be the specific electronic device 110a or the specific electronic device 110b, and the intermediate electronic device 130 may be the intermediate electronic device 130a or the intermediate electronic device 130b.

In step S802, the specific electronic device 110 generates specific data corresponding to a request of a user, and in step S804, transmits and/or broadcast the specific data via a first network 120, such as a wired or wireless network such as Wi-Fi or Bluetooth network by using a network connecting unit 111 of the specific electronic device 110. It is noted that, the specific electronic device 110 can generate the specific data according to different applications and requirements, which will be discussed later. It is understood that, in some embodiments, the network connecting unit 111 may be a network connecting unit implemented with a low-power consumption technology, such as Bluetooth Smart technology. The Bluetooth Smart technology supports two modes, such as central and peripheral. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected by other electronic devices. In step S806, the intermediate electronic device 130 determines whether any specific data is received via a network. Similarly, in some embodiments, the network connecting unit of the intermediate electronic device 130 may be a network connecting unit implemented with a low-power consumption technology, such as Bluetooth Smart technology. The Bluetooth Smart technology supports two modes: central and peripheral. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices. When no specific data is received (No in step S806), the procedure remains at step S806. When specific data is received (Yes in step S806), in step S808, the intermediate electronic device 130 transmits the received specific data to a server 150 via a second network 140, such as a wired or wireless network. On the other hand, in step S810, the server 150 determines whether any specific data is received from the intermediate electronic device 130 or not. When no specific data is received (No in step S810), the procedure remains at step S810. When the specific data corresponding to the intermediate electronic devices 130 is received via a network (Yes in step S810), in step S812, the server 150 performs a request management process for the received specific data. It is noted that, the request management process is performed according to the time at which the specific data D is received by the intermediate electronic device 130 or the server 150. It is understood that, in some embodiments, the request management process calculates an accumulated time after the specific data D is received by the intermediate electronic device 130 or the server 150. Then, in step S814, it is determined whether a result of the request management process conforms to a predefined condition. When a result of the request management process does not conform to a predefined condition (No in step S814), the procedure returns to step S812. When a result of the request management process conforms to a predefined condition (Yes in step S814), in step S816, a reminder is generated to prompt the request corresponding to the specific electronic device by the server 150. As described, in some embodiments, the request management process calculates an accumulated time after the specific data D is received by the intermediate electronic device 130 or the server 150. When the accumulated time equals to a predefined time value, it represents that the result of the request management process conforms to the predefined condition, and the reminder is generated. Similarly, in some embodiments, the reminder may comprise a sound, vibration, or any data, such as text or figure, which can be displayed. Additionally, in some embodiments, the server 150 can display the result of the request management process via a display unit. It is noted that, the presentation manner of the result of the request management process can be implemented based on various designs.

It is noted that, in some embodiments, the identification data corresponding to the specific electronic device 110 can be transmitted along with the specific data generated by the specific electronic device 110. The server 150 will record and perform subsequent managements for the received identification data and the specific data. Additionally, as described, in some embodiments, a terminal electronic device, such as a smart phone can connect to the server 150, and obtain and display the specific data and the result of the request management process from the server 150.

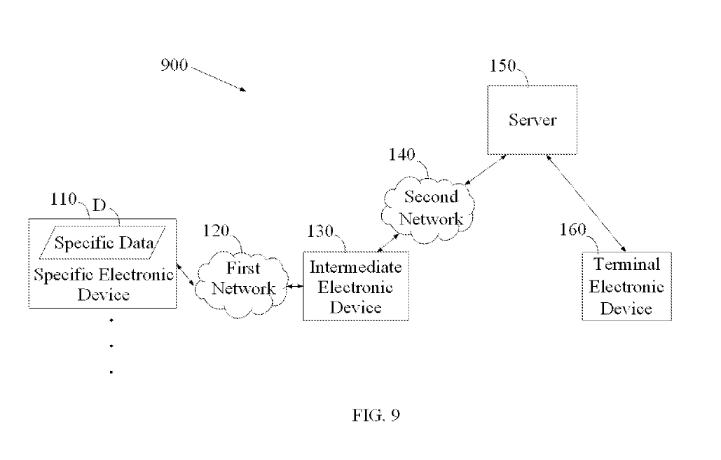

FIG. 9 is a schematic diagram illustrating another embodiment of a system for reminding user requests of the invention. The system for reminding user requests 900 comprises at least one specific electronic device 110, an intermediate electronic device 130, a server 150, and a terminal electronic device 160. The specific electronic device 110 and the intermediate electronic device 130 may be any electronic device having network connecting capabilities. The specific electronic device 110 can generate specific data D corresponding to a request of a user, and transmit and/or broadcast the specific data D via a first network 120, such as a wired or a wireless network such as a Wi-Fi or a Bluetooth network. The intermediate electronic device 130 can receive the specific data D, which is transmitted from the different specific electronic devices 110a via the first network 120, and transmit the specific data D to the server 150 via a second network 140, such as a wired or a wireless network. The server 150 can record the specific data D corresponding to the respective specific electronic device 110, and provide/synchronize the specific data D to the terminal electronic device 160. The terminal electronic device 160 can perform a request management process for the specific data D corresponding to the specific electronic device 110, which will be discussed later.

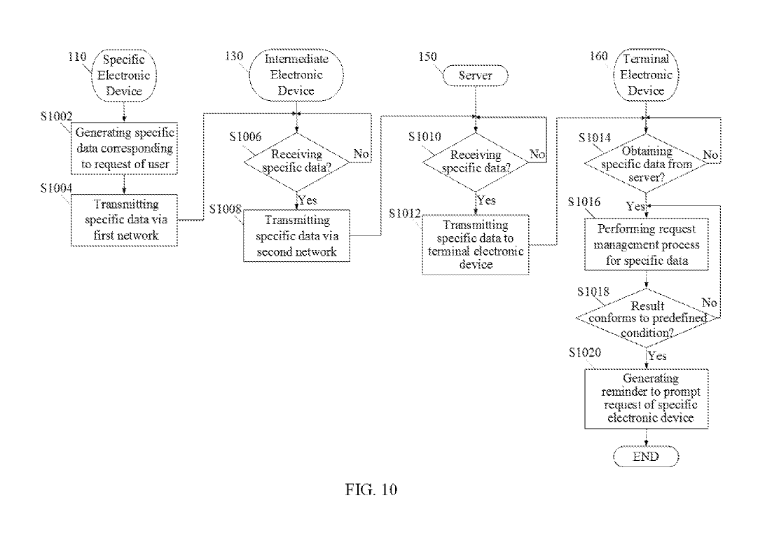

FIG. 10 is a flowchart of another embodiment of a method for reminding user requests of the invention.

In step S1002, the specific electronic device 110 generates specific data corresponding to a request of a user, and in step S1004, transmits and/or broadcast the specific data via a first network 120, such as a wired or wireless network such as Wi-Fi or Bluetooth network by using a network connecting unit 111 of the specific electronic device 110. It is noted that, the specific electronic device 110 can generate the specific data according to different applications and requirements, which will be discussed later. It is understood that, in some embodiments, the network connecting unit 111 may be a network connecting unit implemented with a low-power consumption technology, such as Bluetooth Smart technology. The Bluetooth Smart technology supports two modes, such as central and peripheral. In some embodiments, the network connecting unit 111 is in the peripheral mode. In other words, the network connecting unit 111 has data broadcasting capabilities, and the network connecting unit 111 cannot actively connect to other electronic devices, wherein the network connecting unit 111 can be passively connected by other electronic devices. In step S1006, the intermediate electronic device 130 determines whether any specific data is received via a network. Similarly, in some embodiments, the network connecting unit of the intermediate electronic device 130 may be a network connecting unit implemented with a low-power consumption technology, such as Bluetooth Smart technology. The Bluetooth Smart technology supports two modes: central and peripheral. In some embodiments, the network connecting unit of the intermediate electronic device 130 is in the central mode. In other words, the network connecting unit of the intermediate electronic device 130 has data receiving capabilities, and the network connecting unit of the intermediate electronic device 130 can actively connect to other electronic devices. When no specific data is received (No in step S1006), the procedure remains at step S1006. When specific data is received (Yes in step S1006), in step S1008, the intermediate electronic device 130 transmits the received specific data to a server 150 via a second network 140, such as a wired or wireless network. On the other hand, in step S1010, the server 150 determines whether any specific data is received from the intermediate electronic device 130 or not. When no specific data is received (No in step S1010), the procedure remains at step S1010. When the specific data corresponding to the intermediate electronic devices 130 is received via a network (Yes in step S1010), in step S1012, the server 150 provides/synchronizes the specific data to a terminal electronic device 160. On the other hand, in step S1014, the terminal electronic device 160 determines whether any specific data is received from the server 150 via a network or not. When no specific data is obtained from the server 150 (No in step S1040), the procedure remains at step S1014. When the specific data is obtained from the server 150 (Yes in step S1040), in step S1016, the terminal electronic device 160 performs a request management process for the specific data. It is noted that, the request management process is performed according to the time at which the specific data D is received by the intermediate electronic device 130, the server 150, or the terminal electronic device 160. It is understood that, in some embodiments, the request management process calculates an accumulated time after the specific data D is received by the intermediate electronic device 130, the server 150, or the terminal electronic device 160. Then, in step S1018, it is determined whether a result of the request management process conforms to a predefined condition. When a result of the request management process does not conform to a predefined condition (No in step S1018), the procedure returns to step S1016. When a result of the request management process conforms to a predefined condition (Yes in step S1018), in step S1020, a reminder is generated to prompt the request corresponding to the specific electronic device by the terminal electronic device 160. As described, in some embodiments, the request management process calculates an accumulated time after the specific data D is received by the intermediate electronic device 130, the server 150, or the terminal electronic device 160. When the accumulated time equals to a predefined time value, it represents that the result of the request management process conforms to the predefined condition, and the reminder is generated. Similarly, in some embodiments, the reminder may comprise a sound, vibration, or any data, such as text or figure, which can be displayed. Additionally, in some embodiments, the terminal electronic device 160 can display the result of the request management process via a display unit. It is noted that, the presentation manner of the result of the request management process can be implemented based on various designs.

It is noted that, in some embodiments, the identification data corresponding to the specific electronic device 110 can be transmitted along with the specific data generated by the specific electronic device 110. The terminal electronic device 160 will record and perform subsequent managements for the received identification data and the specific data.

As described, the specific electronic device 110 can generate the specific data according to different applications and requirements.

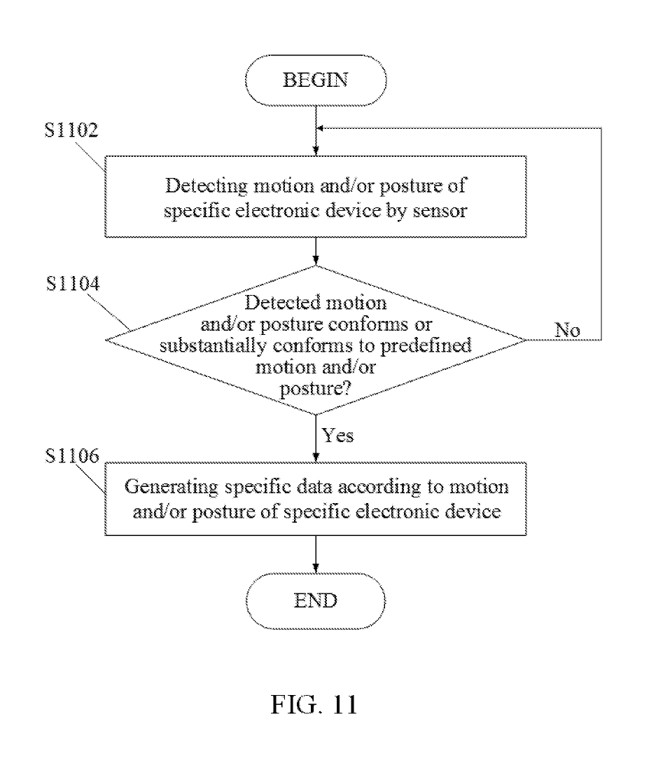

FIG. 11 is a flowchart of an embodiment of a method for generating specific data of the invention. In step S1102, at least one sensor detects a motion and/or posture corresponding to the specific electronic device 110. It is understood that, in some embodiments, the sensor may be an accelerometer for generating information of velocity and displacement when the device moves. In some embodiments, the sensor may be a Gyro sensor for generating information of angular acceleration when the device moves. In some embodiments, the motion sensor may be an e-compass for detecting an angle of the device in regard to a geographical direction, such as the direction of the North Pole or the South Pole. It is noted that, the above sensors are only examples of the present application, and the present invention is not limited thereto. Any sensor that can detect the posture and/or motion of an electronic device can be applied in the present invention. As described, the sensor can detect the posture of the specific electronic device. It is understood that, in some embodiments, the posture can be the angular information of the specific electronic device in regard to at least one reference point. In some embodiments, the posture of the specific electronic device can be represented by an angle corresponding to an axis which is vertical to at least one plane of the specific electronic device in regard to a specific direction, such as the gravity direction or the geographical direction. In step S1104, it is determined whether the motion and/or posture of the specific electronic device 110 conforms or substantially conforms to at least one predefined motion and/or posture. When the motion and/or posture of the specific electronic device 110 does not conform or substantially conform to the predefined motion and/or posture (No in step S1104), the procedure returns to step S1102. When the motion and/or posture of the specific electronic device 110 conforms or substantially conforms to the predefined motion and/or posture (Yes in step S1104), in step S1106, specific data is generated according to the motion and/or posture of the specific electronic device 110. It is understood that, in some embodiments, the specific electronic device 110 can generate different specific data according to different motions and/or posture, and the intermediate electronic device 130, the server 150, or the terminal electronic device 160 can perform different request management processes according to the different specific data.

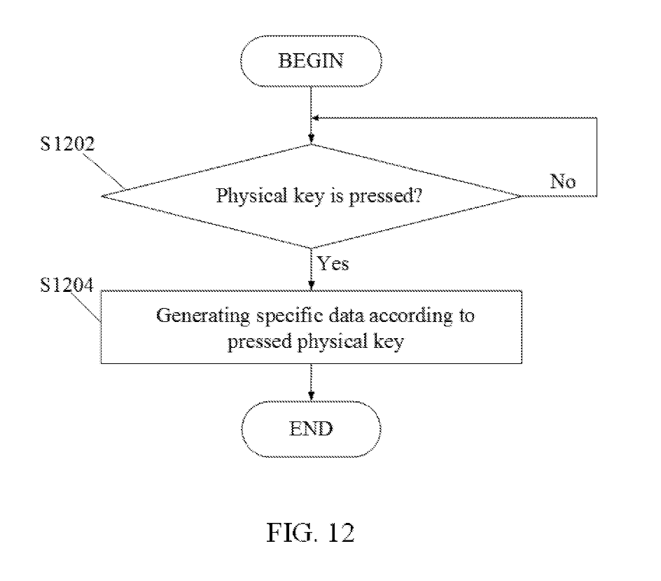

FIG. 12 is a flowchart of another embodiment of a method for generating specific data of the invention. In step S1202, it is determined whether at least one physical key of the specific electronic device 110 is pressed or not. When the physical key is not pressed (No in step S1202), the procedure remains at step S1202. When the physical key is pressed (Yes in step S1202), in step S1204, specific data is generated according to the pressed physical key. Similarly, the specific electronic device 110 can generate different specific data according to different physical keys which have been pressed, and the intermediate electronic device 130, the server 150, or the terminal electronic device 160 can perform different request management processes according to the different specific data.

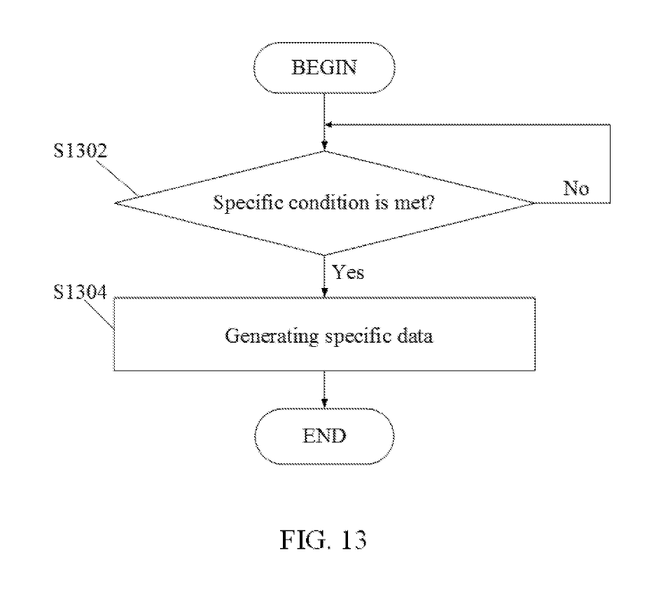

FIG. 13 is a flowchart of another embodiment of a method for generating specific data of the invention. In step S1302, the specific electronic device 110 determines whether a specific condition is met or not. It is noted that, the specific condition may be different according to different requirements and applications. For example, the specific condition may be a specific time. When the current time reaches the specific time, the specific condition is met. In another example, the specific condition may be a specific region. When the location of the specific electronic device 110 is within the specific region, the specific condition is met. In another example, a sensor of the specific electronic device 110 can detect related data, such as an environmental factor, and it is determined whether the detected data conforms to a specific threshold value or a specific state. When the detected data conforms to the specific threshold value or the specific state, the specific condition is met. For example, the sensor may be a temperature sensor for detecting the temperature of an environment where the specific electronic device 110 is in. In another example, the sensor may be a pressure sensor for detecting the pressure of an environment where the specific electronic device 110 is in. It is noted that, the above sensors are only examples of the present application, and the present invention is not limited thereto. When the specific condition is not met (No in step S1302), the procedure remains at step S1302. When the specific condition is met (Yes in step S1302), in step S1304, specific data is generated. Similarly, the specific electronic device 110 can generate different specific data according to different specific conditions, and the intermediate electronic device 130, the server 150, or the terminal electronic device 160 can perform different request management processes according to the different specific data.

It is understood that, in some embodiments, the specific electronic device 110 can optionally enter a sleep mode after a specific period subsequent to the transmission of the specific data. In some embodiments, the specific electronic device 110 can continuously transmit the generated specific data in a predefined period via a wireless network, stop transmitting the specific data after the predefined period, and optionally enter a sleep mode. In some embodiments, the specific electronic device 110 can continuously transmit the generated specific data via a wireless network. After the intermediate electronic device 130 receives the specific data transmitted by the specific electronic device 110, the intermediate electronic device 130 can connect to the specific electronic device 110, and instruct the specific electronic device 110 to stop generating and transmitting the specific data.

For example, a restaurant may have several partitions, wherein an intermediate electronic device can be deployed in each of the partitions, and a specific electronic device can be set on each table of the respective partitions. It is noted that, each intermediate electronic device can receive the specific data generated by the respective specific electronic devices in the corresponding partition. When a customer needs a specific service, the customer can press a physical key of the specific electronic device, or instruct the specific electronic device to generate a predefined motion or place the specific electronic device in a predefined posture, thus driving the specific electronic device to generate and broadcast specific data via a wireless network, such as a Bluetooth network. It is noted that, the specific data may represent that the customer needs the specific service. At the time, the intermediate electronic device, such as a smart phone or a tablet computer can receive the specific data broadcasted by the specific electronic device via a wireless network, and transmit the specific data and/or the identification data corresponding to the specific electronic device to a server. It is noted that, any intermediate electronic device in the respective partitions will transmit the specific data and/or the identification data corresponding to the specific electronic device to the server once the specific data is received. In a case, the server will perform a request management process for the received specific data. For example, a predefined time value, such as 3 minutes is counted down after the specific data is received. In another case, the server can synchronize the specific data to a terminal electronic device, such as a smart phone or a tablet computer corresponding to a manager. Similarly, after the specific data is received, the terminal electronic device performs a request management process for the received specific data. When a result of the request management process conforms to a predefined condition, for example, when the counted down time value equals to 0, the server and/or the terminal electronic device will generate a reminder to prompt the specific data corresponding to the specific electronic device. It is noted that, a waiter can be reminded to respond the user request as soon as possible via the reminder. It is noted that, the example in a restaurant is only an example of the present application, and the present invention is not limited thereto. The specific electronic device can be deployed in any place, such as a restaurant, hospital, school, store, sports course, factory, or house.

Therefore, the methods and system for reminding user requests of the present invention can receive data corresponding to user requests from an electronic device, perform related managements for the received data, and perform related reminding processes for the requests, thereby reducing the drawbacks of conventional service managements, accomplishing the objective of information management, and further increasing the satisfactory when using related services.

Methods for reminding user requests, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for reminding user requests, comprising:
generating specific data corresponding to a request of a user, and transmitting the specific data via a first network by at least one specific electronic device;
receiving the specific data from the at least one specific electronic device via the first network by an intermediate electronic device;
performing a request management process for the specific data by the intermediate electronic device, wherein the request management process is performed according to the time at which the specific data is received by the intermediate electronic device; and
generating a reminder to prompt the request corresponding to the at least one specific electronic device by the intermediate electronic device when a result of the request management process conforms to a predefined condition.

2. The method of claim 1, wherein the request management process calculates an accumulated time after the specific data is received by the intermediate electronic device, and when the accumulated time equals to a predefined time value, the reminder is generated.

3. The method of claim 1, wherein the specific electronic device comprises at least one sensor for detecting a motion or posture corresponding to the specific electronic device, and the specific electronic device generates the specific data according to the motion or posture corresponding to the specific electronic device.

4. The method of claim 1, wherein the specific electronic device comprises at least one physical key, and the specific electronic device generates the specific data when the physical key is pressed.

5. The method of claim 1, wherein the specific electronic device determines whether a specific condition is met or not, and the specific electronic

6. A method for reminding user requests, comprising:
generating specific data corresponding to a request of a user, and transmitting the specific data via a first network by at least one specific electronic device;
receiving the specific data from the at least one specific electronic device via the first network by an intermediate electronic device;
transmitting the specific data to a server via a second network by the intermediate electronic device;
performing a request management process for the specific data by the server, wherein the request management process is performed according to the time at which the specific data is received by the intermediate electronic device or the server; and
generating a reminder to prompt the request corresponding to the at least one specific electronic device by the server when a result of the request management process conforms to a predefined condition.

7. The method of claim 6, further comprising obtaining the specific data and the result of the request management process from the server by a terminal electronic device.

8. The method of claim 6, wherein the request management process calculates an accumulated time after the specific data is received by the intermediate electronic device or the server, and when the accumulated time equals to a predefined time value, the reminder is generated.

9. A method for reminding user requests, comprising:
generating specific data corresponding to a request of a user, and transmitting the specific data via a first network by at least one specific electronic device;
receiving the specific data from the at least one specific electronic device via the first network by an intermediate electronic device;
transmitting the specific data to a server via a second network by the intermediate electronic device;
performing a request management process for the specific data by the terminal electronic device, wherein the request management process is performed according to the time at which the specific data is received by the intermediate electronic device, the server or the terminal electronic device; and
generating a reminder to prompt the request corresponding to the at least one specific electronic device by the terminal electronic device when a result of the request management process conforms to a predefined condition.

10. A system for reminding user requests, comprising:
at least one specific electronic device generating specific data corresponding to a request of a user, and transmitting the specific data via a first network; and
an intermediate electronic device receiving the specific data from the at least one specific electronic device via the first network, performing a request management process for the specific data, wherein the request management process is performed according to the time at which the specific data is received by the intermediate electronic device, and generating a reminder to prompt the request corresponding to the at least one specific electronic device when a result of the request management process conforms to a predefined condition.

11. A system for reminding user requests, comprising:
at least one specific electronic device generating specific data corresponding to a request of a user, and transmitting the specific data via a first network;
an intermediate electronic device receiving the specific data from the at least one specific electronic device via the first network, and transmitting the specific data via a second network; and
a server receiving the specific data via the second network, performing a request management process for the specific data, wherein the request management process is performed according to the time at which the specific data is received by the intermediate electronic device or the server, and generating a reminder to prompt the request corresponding to the at least one specific electronic device when a result of the request management process conforms to a predefined condition.

12. A system for reminding user requests, comprising:
at least one specific electronic device generating specific data corresponding to a request of a user, and transmitting the specific data via a first network;
an intermediate electronic device receiving the specific data from the at least one specific electronic device via the first network, and transmitting the specific data via a second network;
a server receiving the specific data via the second network; and
a terminal electronic device obtaining the specific data from the server, performing a request management process for the specific data, wherein the request management process is performed according to the time at which the specific data is received by the intermediate electronic device, the server or the terminal electronic device, and generating a reminder to prompt the request corresponding to the at least one specific electronic device when a result of the request management process conforms to a predefined condition.
